(19) United States
(12) Patent Application Publication
(10) Pub. No.: US 2015/0296888 A1
(43) Pub. Date: Oct. 22, 2015

(54) ELECTRONIC CIGARETTE

(71) Applicant: KIMREE HI-TECH INC., Tortola (VG)

(72) Inventor: Qiuming Liu, Huizhou City (CN)

(21) Appl. No.: 14/414,891

(22) PCT Filed: May 29, 2013
(86) PCT No.: PCT/CN2013/076389

§ 371 Date: Jan. 14, 2015

(51) Int. Cl. A24F 47/00; H05B 37/02

(52) U.S. Cl. CPC A24F 47/008; H05B 37/0227

(57) ABSTRACT

An electronic cigarette comprising a power supply (30) and a light source (40) used for emulating a burning cigarette, also comprising a control module (50) connected to the power supply (30) and to the light source (40). The light source (40) comprises multiple light-emitting units. The control module (50) controls, on the basis of a user operation, the light source (40) to emit a light emulating the burning cigarette. By employing the technical means whereby the control module (50) arranged at the power supply (30) and at the light source (40) comprising the multiple light-emitting units controls, on the basis of the user operation, the light source (40) to emit the light emulating the burning cigarette, the electronic cigarette is capable of implementing emulation under user control scenarios of various burning cigarettes, thus achieving the technical effect of improved vividness whereby the light emitted by the electronic cigarette is of increased likeness to actual smoking.

### FIELD OF THE INVENTION

The present invention relates to an electronic cigarette.

### BACKGROUND OF THE INVENTION

Electronic cigarette is a simulation cigarette, using heating wire to heat and atomize substance containing fragrance to produce smoke for users smoking A conventional electronic cigarette usually comprises an inhalation rod and a power supply rod. One end of the power supply rod disposes an indication light and a light cap which is capping on the indication light. However, when smoking, the indication light emits dull light only, thus shows poor simulation.

### SUMMARY OF THE INVENTION

Therefore, the present invention provides an electronic cigarette of high simulation.

In order to achieve the above-mentioned objective, an embodiment of the present invention provides an electronic cigarette, includes a power supply and a light source used for simulating cigarette burning. The electronic cigarette further includes a control module which is connected with the power supply and the light source. The light source includes multiple light-emitting units which are mutually cooperating to simulate cigarette burning. The control module controls the light source to emit light simulating to cigarette burning according to users operation. Therefore, by the control module and the light source composed of multiple light-emitting units, the electronic cigarette achieves simulating variety cigarette burning conditions under user control.

Furthermore, the light-emitting unit is point light source. The multiple point light sources are orderly arranged as cylinder shape and/or curved surface. Every point light source is composed of an LED light. Therefore, the point light source being arranged as cylinder shape makes the simulated burning cigarette more stereo feeling, and the effect is more realistic.

Furthermore, the light-emitting unit is an annular light source or a strip light source. The annular light source or the strip light source is orderly arranged as cylinder shape. The annular light source and the strip light source are composed of an LED light and a light guiding unit which is capping on the LED light. The annular light source or the strip light source composed of the light guiding unit makes the emitted light more uniform, and the effect is more realistic.

Furthermore, the control module is a switch. Preferably, the switch is a touch switch or a button switch.

Furthermore, the electronic cigarette further includes an airflow sensor which is used for sensing users smoking action. The control module is a microprocessor. The microprocessor controls the light source to emit light simulating cigarette burning according to the sensing signal of the airflow sensor. Therefore, by the airflow sensor and the microprocessor controlling the light source to emit light makes the light source emitting light associating with the users smoking action, more close to real smoking, and the effect is more realistic.

Furthermore, the microprocessor delays a predetermined time to control the light source to emit light simulating cigarette burning according to the sensing signal of the airflow sensor. Preferably, the delayed predetermined time is one to three seconds, which further is closer to real smoking, and the effect is more realistic.

Furthermore, the electronic cigarette further includes a current limiting circuit or a pulse width modulation circuit which is connected between the light source and the power supply and is used for adjusting the brightness of the power supply. Herein, there are two ways to control the LED brightness: one way is use the current limiting circuit to change the working current flowing through the LED, the current limiting circuit and the control module and the light source are connected in series to form a loop, then the LED brightness is basically proportional to the current flowing through; another way is based on human visual persistence, using the pulse width modulation method of the pulse width modulation circuit to achieve control, that is periodically changing the optical pulse width (the duty ratio), as long as the repeat lighting up cycle is short enough (the refresh rate is high enough), human eyes will not feeling that the light emitting pixel is jittering. Because pulse width modulation is more suitable for digital control, thus pulse width modulation is adopted to control. Preferably, the pulse width modulation circuit is disposed at an outer of the microprocessor or is integrated in the microprocessor.

Furthermore, each light-emitting unit emits one kind of light of red light, white light, yellow light or blue light.

Furthermore, the light emitted by the light source simulating cigarette burning is light of different brightness or brightness changing.

Furthermore, the light emitted by the light source simulating cigarette burning is light of different colors.

Furthermore, the light colors emitted by the light source are arranged orderly as grey, dark red and bright red along a direction from a cigarette rod end to a mouthpiece end.

Furthermore, the light source is arranged on a flexible circuit board. Therefore, the light source can be folded, and is convenient installation.

Furthermore, the light emitted by the light source simulating cigarette burning is light of color changing.

Furthermore, the light colors emitted by the light source are arranged orderly as grey, dark red and bright red along the direction from a cigarette rod end to a mouthpiece end, and emit light as a predetermined time in turn according to the order. Therefore, the light source emits light more dynamic, further closer to real smoking, and the effect is more realistic.

Furthermore, the bright red light is emitted sparklingly to simulate burning state.

Furthermore, the dark red light and the bright red light are emitted sparklingly to simulate burning state.

Furthermore, the light colors emitted by the light source are arranged orderly as grey, dark red and bright red along the direction from a cigarette rod end to a mouthpiece end, and emit light at the same time; and the bright red light is emitted sparklingly to simulate burning state.

Furthermore, the light-emitting unit is point light sources which are arranged as a curved surface. Every point light source is composed of an LED light. Wherein, the curved surface is preferably a circular or a spherical surface. The structure of the point light source arranged in curved surface is simple, easy to manufacture, and can simulate the realistic effect of the cigarette burning state.

Furthermore, the point light sources are arranged according to a predetermined order of color and/or brightness.

Beneficial effects of the electronic cigarette of the embodiment of the present invention are: by the technical means of using the control module which is disposed and connected with the power supply and the light source, wherein the light source includes multiple light-emitting units which are mutually cooperated to simulate cigarette burning, and the control module controls the light source to emit light simulating cigarette burning according to users operation, therefore achieves simulating various states of cigarette burning under users control, then achieves the technical effects that the electronic cigarette further closer to real smoking, and the effect is more realistic.

### BRIEF DESCRIPTION OF THE DRAWINGS

FIG. 1 is a schematic view of a whole structure of an electronic cigarette according to one embodiment of the present invention.

FIG. 2 is a sectional view along A-A direction of the electronic cigarette shown in FIG. 1.

FIG. 3 is an exploded view of the electronic cigarette according to the embodiment of the present invention.

FIG. 4 is a schematic view of a circuit of the electronic cigarette according to the embodiment of the present invention.

FIG. 5 is a schematic view of a point light source of the electronic cigarette according to the embodiment of the present invention.

FIG. 6 is a schematic view of an annual light source of the electronic cigarette according to the embodiment of the present invention.

FIG. 7 is a schematic view of a strip light source of the electronic cigarette according to the embodiment of the present invention.

### DETAILED DESCRIPTION OF THE INVENTION

It is needed to state that embodiments and all element limitations in all embodiments may be combined in the case of no conflicts. The present invention will be described in detail in the following combining figures and embodiments.

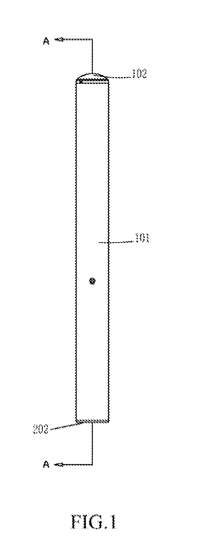

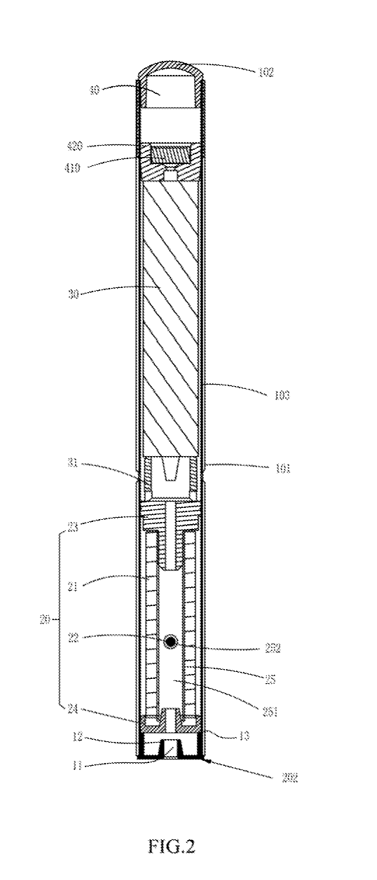

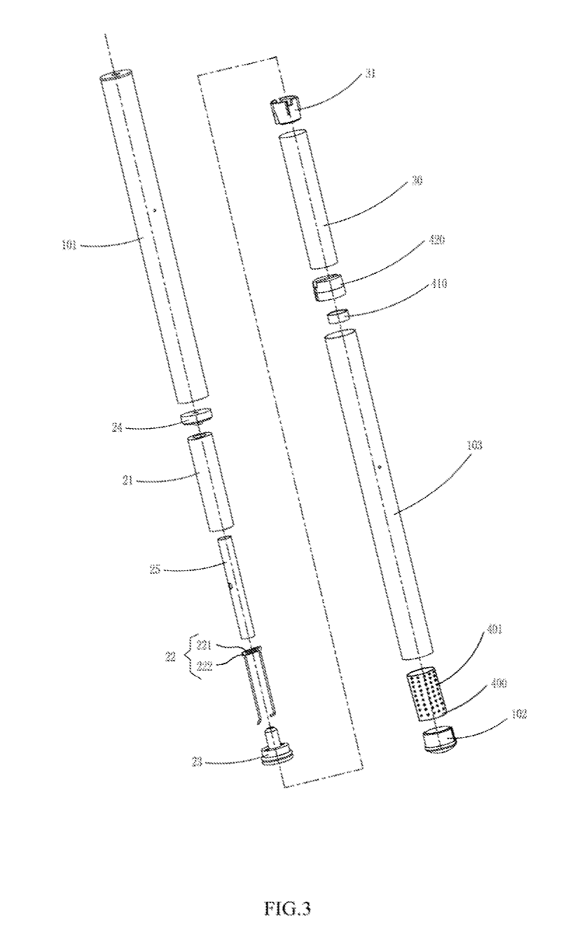

Referring to FIG. 1 to FIG. 3, the present invention provides an electronic cigarette, including a main rod body 101 and a transparent cover body 102 which is matched and installed with the main rod body 101.

The main rod body 101 is a cylinder structure with one end opening and inside hollow. The cover body 102 is securely installed at the opening end of the main rod body 101 to cooperate with the main rod body 101 to seal the electronic cigarette. A center of a bottom wall of the other end of the main rod body 101 axially defines an inhalation hole 11 through the bottom wall, to form a mouthpiece end 202 used for smoking the electronic cigarette. An inner wall of the inhalation hole 11 axially extends toward the inside of the main rod body 101 to form an air guide column 12 used for guiding smoke flowing.

In the embodiment, the main rod body 101 may be made of materials such as metal, plastic, paper, wood and etc. A shape of the main rod body 101 is preferably arranged as a cylinder structure of the same shape to real cigarette of which cross section is round to enhance the simulation of the electronic cigarette. Certainly, the main rod body 101 may also be a cylinder structure of which cross section is polygonal or other combined shape according to design requirements to rich the external shape of the electronic cigarette.

The main rod body 101 disposes an atomization device 20 and a power supply 30 therein. The atomization device 20 is used to atomize E-liquid to smoke for users smoking The power supply 30 is preferably a lithium battery.

The atomization device 20 includes a liquid-storage part 21, an electro-heating assembly 22, an atomization seat 23 and a sealing ring 24.

The atomization device 20 is close to the mouthpiece end 202 of the main rod body 101. An inner wall of the mouthpiece end 202 of the main rod body 101 radially extends to form a boss 13, which is used to abut to the sealing ring 24.

The liquid-storage part 21 has capability of absorbing liquid and storing liquid, and is used to absorb and store E-liquid to facilitate the electro-heating assembly 22 to atomize the E-liquid subsequently. In the embodiment, the liquid-storage part 21 may be made of materials capable of absorbing liquid and storing liquid such as glass fiber, non-woven fabric, wood pulp fiber, chemical fiber, polyvinyl alcohol, high temperature cotton, chemical fiber cotton, mixed cotton, liquid-absorbing cotton, nickel foam, and so on.

In the embodiment, the liquid-storage part 21 is arranged as a hollow tube structure matching with the main rod body 101, and is coaxially arranged with the main rod body 101. The liquid-storage part 21 is supported and fixed between the atomization seat 23 and the sealing ring 24 by a support tube 25. A central of the support tube 25 forms an atomization chamber 251 which is used to conduct air path and accommodate the electro-heating assembly 22.

The electro-heating assembly 22 is used to atomize E-liquid to smoke. In the embodiment, the electro-heating assembly 22 is composed of a heating wire 221 and a glass fiber wire 222. The heating wire 221 winds on the glass fiber wire 222.

In the embodiment, the glass fiber wire 222 is radially disposed in the support tube 25. A sidewall of the support tube 25 correspondingly defines a bayonet 252 through the sidewall along the radial direction. Two ends of the glass fiber wire 222 extends out the support tube 25 from the bayonet 252 and abuts with an inner wall of the liquid-storage part 21, therefore to absorb the E-liquid in the liquid-storage part 21 to supply the heating wire 221 to heat and atomize.

In the embodiment, an outer contour of the atomization seat 23 and the sealing ring 24 are fitting with an inner contour of the main rod body 101 and preferably arranged as interferingly fit. Both the atomization seat 23 and the sealing ring 24 use outer walls thereof to be tensioning fixed in the main rod body 101 so as to seal and fix the liquid-storage part 21 in the main rod body 101. A central of the atomization seat 23 and a central of the sealing ring 24 respectively and correspondingly define ventilation holes communicating with the atomization chamber 251, thus used for conducting air path.

The power supply 30 is disposed at one side of the atomization seat 23 away from the liquid-storage part 21, and is supported and fixed in the main rod body 101 by a support seat 31. A sidewall of the atomization seat 23 axially defines threading holes used for the heating wire 221 passing through.

The opening end of the main rod body 101 further disposes a light source 40. The light source 40 is used to simulate cigarette burning. The light source 40 includes multiple light-emitting units which are mutually cooperating to simulate cigarette burning. The light source 40 is covered with the cover body 102. A whole or at least end surface of the cover body 102 is arranged as transparent or semi-transparent. In the embodiment, the whole of cover body 102 is made of transparent plastic material.

In the main rod body 101 also disposes a control module 50 used to connect the atomization device 20, the power supply 30 and the light source 40. The control module 50 controls the light source 40 to emit light simulating cigarette burning according to users operation. The control module 50 is electrically connected with the power supply 30 and the atomization device 20 respectively, thus controlling the atomization device 20 and the light source 40 power-on or power-off.

As an embodiment, the control module 50 is a switch, which is preferably arranged at the end of the power supply 30 away from the atomization device 20. Specifically, the switch may be a touch switch or a button switch. When turning on the switch, the electronic cigarette works, the light-emitting units respectively emit light having different colors, and the light having different colors mutually cooperate to form gray, red or gradient light from gray to red, therefore achieves simulating cigarette burning.

Referring also to FIG. 4, as an embodiment, the control module 50 is a microprocessor. The electronic cigarette also includes an airflow sensor 410 which is connected with the microprocessor and is used to sense users smoking action. The airflow sensor 410 is fixed in the battery rod 103 by a fixing seat 420. The microprocessor controls the light source 40 to emit light simulating cigarette burning according to the signal from the airflow sensor 410. That is, when users smoking by the mouthpiece end 102 of the main rod body 101, a cavity of the electronic cigarette generates negative pressure, then makes the airflow sensor 410 generates pulse signal, the microprocessor controls to connect a power supply circuit between the atomization device 20 and the power supply 30 according to the pulse signal.

As an embodiment, according to the sensing signal from the airflow sensor 410, the microprocessor controls the light source 40 to emit light simulating cigarette burning after a delayed predetermined time. Preferably, the delayed predetermined time is one to three seconds, further closer to real smoking, and the effect is more realistic.

Each light-emitting unit emits one kind of light of red light, white light, yellow light or blue light. The light source 40 is arranged on a flexible circuit board 400. Therefore, the light source 40 can be folded, thus convenient installation.

In terms of the arrangement structure the light-emitting units, the light source 40 is divided as cylinder shape and curved surface shape. Wherein, the curved surface is preferably arranged as spherical shape or round shape. Certainly, one skilled in the art may understand that, the arrangement structures may be combined to use, for example the light source 40 is arranged as cylinder shape at a side of the electronic cigarette and at the same time being arranged as spherical shape at the end surface. The cylinder shape further may be formed by the arrangement of a point light source 401, an annular light source 402 or a strip light source 403. The spherical shape is formed by the arrangement of the point light source 401.

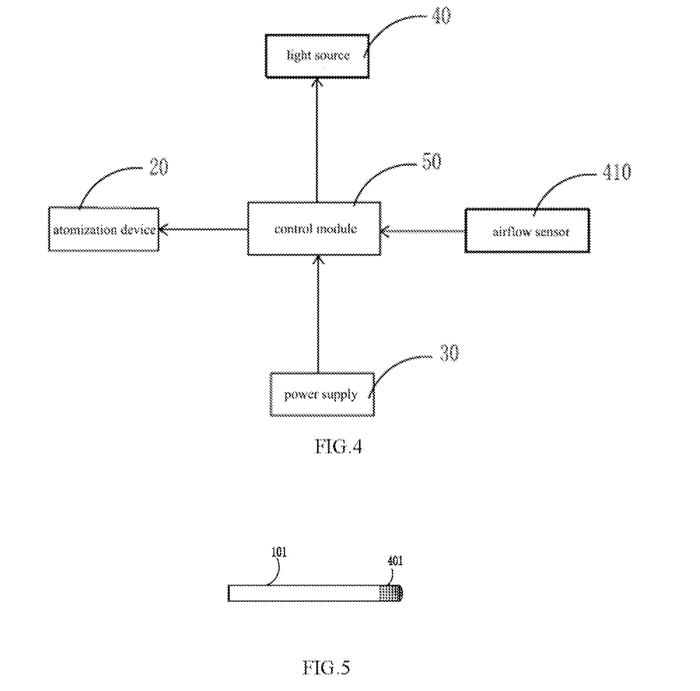

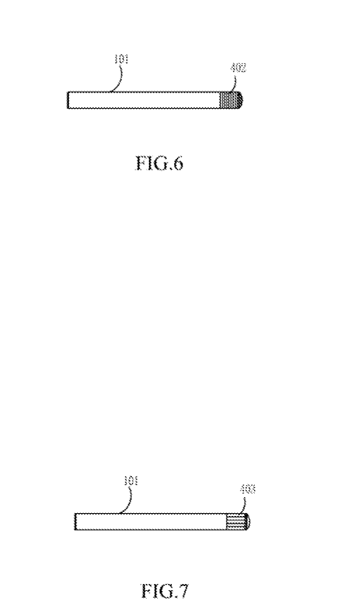

Specifically, referring to FIG. 5, as a first embodiment, the light-emitting unit is the point light source 401. The multiple point light sources 401 disposed in the main rod body 101 are orderly arranged as a cylinder shape, and the multiple point light sources 401 disposed in the cover body 102 are arranged as a spherical shape. Every point light source 401 is composed of one LED. Therefore, it makes the simulated burning cigarette more stereo feeling, and the effect is more realistic. Referring to FIG. 6 and FIG. 7, as a second embodiment, the light-emitting unit is an annular light source 402 or a strip light source 403 which are orderly arranged as cylinder shape. The annular light source 402 and the strip light source 403 are composed of an LED light and light a guiding unit which is capping on the LED light. The annular light source 402 or the strip light source 403 composed of the light guiding unit makes the emitted light more uniform, and the effect is more realistic. As a third embodiment, the light-emitting unit is the point light sources 401 which are arranged as a curved surface, every point light source 401 is composed of a LED light. Furthermore, the point light sources 401 are arranged according to a predetermined order of color and/or brightness.

In terms of emitting mode of the light-emitting units, the light source 40 is divided to different brightness light or brightness changing light of the emitted simulating cigarette burning, and different color light or color changing light.

Specifically, the electronic cigarette further includes a current limiting circuit or a pulse width modulation circuit which is connected between the light source 40 and the power supply 30 and is used for adjusting the brightness of the power supply 40. Preferably, the current limiting circuit works under the control of the switch. Preferably, the pulse width modulation circuit is disposed at an outer of the microprocessor or is integrated in the microprocessor.

As a first embodiment, the light colors emitted by the light source 40 are arranged orderly as grey, dark red and bright red along a direction from a cigarette rod end to the mouthpiece end. As a second embodiment, the light colors emitted by the light source 40 are arranged orderly as grey, dark red and bright red along the direction from the cigarette rod end to the mouthpiece end, and emit light for a predetermined time in turn according to the order. Therefore, the light source 40 emits light more dynamic, further closer to real smoking, and the effect is more realistic. Preferably, the bright red light is emitted sparklingly to simulate burning state. Preferably, the dark red light and the bright red light are emitted sparklingly to simulate burning state. As a third embodiment, the light colors emitted by the light source 40 are arranged orderly as grey, dark red and bright red along the direction from the cigarette rod end to the mouthpiece end, and emit light at the same time; and the bright red light is emitted sparklingly to simulate burning state.

In order to further improve the simulation of the electronic cigarette and strengthen hand feeling, the outer surface of the main rod body 101 is further labeled with a sticker. One side of the sticker towards outside may printed with a pattern which is the same or similar to the appearance of a real cigarette; and the other side of the sticker attaching the main rod body 101 may use one any kind of adhesive capable of achieving mutual sticking with the main rod body 101.

Embodiments of the present invention is shown and described in the above-mentioned. Various improvement and modifications can be made to the embodiments by those skilled in the art without departing from the true spirit and scope of the disclosure. The scope of the present invention is defined by the appended claims and equivalents thereof.

1. An electronic cigarette, comprising:
a power supply; and
a light source used for simulating cigarette burning;
wherein the electronic cigarette further comprises a control module connected with the power supply and the light source, the light source includes multiple light-emitting units mutually cooperating to simulate cigarette burning, the control module controls the light source to emit light simulating to cigarette burning according to users operation.

2. According to the electronic cigarette in claim 1, wherein the light-emitting unit is a point light source, the multiple point light sources are orderly arranged as cylinder shape and/or curved surface, every point light source is composed of an LED (light emitting diode) light.

3. According to the electronic cigarette in claim 1, wherein the light-emitting unit is an annular light source or a strip light source, the annular light source or the strip light source is orderly arranged as cylinder shape, the annular light source and the strip light source are composed of an LED light and a light guiding unit which is capping on the LED light.

4. According to the electronic cigarette in claim 1, wherein the control module is a switch.

5. According to the electronic cigarette in claim 1, wherein the electronic cigarette further includes an airflow sensor used for sensing users smoking action, the control module is a microprocessor, the microprocessor controls the light source to emit light simulating cigarette burning according to the sensing signal of the airflow sensor.

6. According to the electronic cigarette in claim 5, wherein the microprocessor delays a predetermined time to control the light source to emit light simulating cigarette burning according to the sensing signal of the airflow sensor.

7. According to the electronic cigarette in claim 1, wherein the electronic cigarette further includes a current limiting circuit or a pulse width modulation circuit which is connected between the light source and the power supply and is used for adjusting the brightness of the light source.

8. According to the electronic cigarette in claim 1, wherein each light-emitting unit emits one of red light, white light, yellow light or blue light.

9. According to the electronic cigarette in claim 1, wherein the light emitted by the light source simulating cigarette burning is a light of different brightness or brightness changing.

10. According to the electronic cigarette in claim 1, wherein the light emitted by the light source simulating cigarette burning is light having different colors.

11. According to the electronic cigarette in claim 10, wherein the light colors emitted by the light source are arranged orderly as grey, dark red and bright red along a direction from a cigarette rod end to a mouthpiece end.

12. According to the electronic cigarette in claim 1, wherein the light source is arranged on a flexible circuit board.

13. According to the electronic cigarette in claim 1, wherein the light emitted by the light source simulating cigarette burning is light of color changing.

14. According to the electronic cigarette in claim 13, wherein the light colors emitted by the light source are arranged orderly as grey, dark red and bright red along the direction from a cigarette rod end to a mouthpiece end, and emit light as a predetermined time in turn according to the order.

15. According to the electronic cigarette in claim 14, wherein the bright red light is emitted sparklingly to simulate burning state.

16. According to the electronic cigarette in claim 14, wherein the dark red light and the bright red light are emitted sparklingly to simulate burning state.

17. According to the electronic cigarette in claim 13, wherein the light colors emitted by the light source are arranged orderly as grey, dark red and bright red along the direction from a cigarette rod end to a mouthpiece end, and emit light at the same time, and the bright red light is emitted sparklingly to simulate burning state.

18. According to the electronic cigarette in claim 1, wherein the light-emitting unit is point light sources which are arranged as a curved surface, every point light source is composed of an LED light.

19. According to the electronic cigarette in claim 18, wherein the point light sources are arranged according to a predetermined order of color and/or brightness.
